(19) United States
(12) Patent Application Publication
(10) Pub. No.: US 2008/0287331 A1
(43) Pub. Date: Nov. 20, 2008

(54) LOW VOC CLEANING COMPOSITION FOR CLEANING PRINTING BLANKETS AND INK ROLLERS

(76) Inventors: Hai-Hui Lin, Naperville, IL (US); Marc Hein, Naperville, IL (US); Xintong Lu, Naperville, IL (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/859,820

(22) Filed: Sep. 24, 2007

Related U.S. Application Data
(60) Provisional application No. 60/938,917, filed on May 18, 2007.

(51) Int. Cl. C11D 1/38

(52) U.S. Cl. 510/174

(57) ABSTRACT

A cleaning composition for cleaning printing components such as printing blankets and inking rollers is provided having a VOC content of less than about 10%. The composition includes a cationic surfactant containing no halides, a co-microemulsifying surfactant, and a solvent selected from a low-VOC solvent, a VOC-exempt solvent, or combinations thereof. The cleaning composition may be applied to the surface of a printing press component containing ink and then wiped away.

### CROSS-REFERENCE TO RELATED APPLICATIONS

This application claims the benefit of U.S. Provisional Application No. 60/938,917, filed May 18, 2007, entitled LOW VOC CLEANING COMPOSITION FOR CLEANING PRINTING BLANKETS AND INK ROLLERS. The entire contents of said application are hereby incorporated by reference.

### BACKGROUND OF THE INVENTION

The present invention relates to a cleaning composition for cleaning printing components such as printing blankets and inking rollers, and more particularly, to a cleaning composition which provides effective removal of ink from inking rollers and printing blankets while maintaining a volatile organic compound (VOC) level of less than about 10%.

One of the most common commercial printing processes is offset lithography. In this printing process, inking rollers transfer liquid printing ink onto a printing plate to a rubber-surfaced printing blanket or cylindrical sleeve mounted on a blanket cylinder before being transferred to a substrate, such as paper.

There are three major ink-contacting surfaces in the printing press, the image plate, inking rollers and offset blanket, all of which require cleaning between print jobs or during maintenance. The image plate is typically cleaned with a fountain solution, while the inking rollers and offset blanket are typically cleaned with a press cleaner often referred to as press wash, or roller and blanket wash. Typically, the press cleaning compositions contain petroleum-based solvents such as naphtha, mineral spirits, acetone, toluene, xylene. Such solvents have high VOC contents (50 to 100%) which are known to be effective in the removal of ink. However, because of environmental concerns in recent years, it has become desirable to use solvents with lower VOC contents. In addition, prior cleaning compositions containing high VOC solvents often penetrate the offset blanket and cause it to swell, increasing its thickness, which can lead to changes in impression pressure and result in printing defects.

While lower VOC content cleaning compositions have been developed, such compositions have not been found to be as effective in cleaning ink as those having higher VOC contents. In order to be effective in removing ink (typically in the form of a film) from a blanket or ink roller surface, the cleaner should be able to soften or replasticize the dried ink/film, lift the ink film off the surface, and carry the ink droplets in the cleaner medium without re-deposition back to the surface.

Accordingly, there is still a need in the art for an improved cleaning composition for use on printing press components such as ink rollers and printing blankets which provides effective cleaning while maintaining a low VOC content.

### SUMMARY OF THE INVENTION

The present invention meets that need by providing a cleaning composition for cleaning inking rollers and printing blankets which provides effective cleaning while containing equal to or less than about 10% VOC. The cleaning composition is safe for nitrile and EPDM-type blankets and exhibits a low tendency for blanket swelling. In addition, the cleaning composition is non-streaking, thermodynamically stable, optically transparent, water washable, and has a relatively neutral pH.

According to one aspect of the present invention, a cleaning composition for cleaning printing components is provided comprising a cationic surfactant containing no halides, a co-microemulsifying surfactant, and a solvent selected from a low-VOC solvent, a VOC-exempt solvent, or combinations thereof. By “low-VOC solvent,” we mean a composition having a VOC content of less than about 10%±2%. Standard test methods are known by those skilled in the art for determining VOC content. By “VOC-exempt solvent,” we mean a solvent that has been listed by the United States Environmental Protection Agency as exempt from regulation as a VOC.

The cationic surfactant is selected from didecyldimethyl ammonium carbonate or didecyldimethyl ammonium bicarbonate. The co-microemulsifying surfactant is selected from glycols and alcohols.

The low-VOC solvent is selected from methyl and butyl soyeate, methyl and butyl esters of tallow oil, methyl and butyl palmitate, methyl and butyl oleate, and methyl and butyl laureate. The VOC-exempt solvent may be selected from tert butyl acetate (TBAc), methyl acetate (MeAc), para chlorobenzene trifluoride (PCBTF) and acetone.

The cleaning composition may optionally contain additives, including anti-streaking additives such as glycol ethers, rag-drag reduction additives such as alcohol esters, and anti-redeposition additives such as natural gum or cellulose derivatives.

The cleaning composition is preferably provided in the form of a microemulsion and has a dispersed oil phase with a droplet size of preferably less than 100 nm.

In the method of using the cleaning composition, the composition is applied to the surface of a printing press component such as an inking roller or printing blanket which contains ink on its surface. The surface of the component is then wiped to remove the ink residue from the surface thereof.

Accordingly, it is a feature of the present invention to provide a cleaning composition for use on printing components such as inking rollers and printing blankets which provides effective cleaning while maintaining a low VOC content. Other features and advantages of the invention will be apparent from the following description and the appended claims.

### DETAILED DESCRIPTION OF THE PREFERRED EMBODIMENTS

We have found that embodiments of the cleaning compositions of the present invention have a VOC content of less than about 10% (less than 100 g/L as defined by EPA Method 24) while still maintaining the cleaning efficacy of cleaners having a much higher VOC content.

The cleaning compositions are compatible with typical rubber compositions used in ink rollers and printing blankets, such as EPDM and nitrile rubbers.

The cleaning compositions are also non-greasy, i.e., substantially no oily residue remains after cleaning. The compositions have swelling indices of less than 5 (less than 0.005 inch surface swelling upon 24 hour wash/blanket contact), which indicates that there is little dimensional change of the blanket after prolonged contact with the cleaning compositions.

Embodiments of the cleaning compositions contain a cationic surfactant which is free of halide ions such as chlorine, bromine, and iodine. As a result, the compositions are noncorrosive to the metal components in an offset printing press. The surfactant is also compatible with both nitrile and EPDM offset blankets. Suitable cationic surfactants for use in the present invention include dioctyldimethyl ammonium carbonate and dioctyldimethyl ammonium bicarbonate, commercially available from Lonza, Inc. The cationic surfactant component of the composition functions as an emulsifier when it contacts ink on the surface of the printing blanket or ink roller.

Embodiments of the cleaning compositions also contain a surfactant that facilitates the formation of an oil-in-water microemulsion. Such a surfactant may be referred to as a “co-microemulsifier” which is capable of changing the packing of surfactants at the oil-water interface to favor the formation of large curvature and thus the formation of smaller droplets. By “microemulsion,” it is meant an emulsion containing oil phase droplets having a size of less than 100 nm. Suitable surfactants include, but are not limited to, glycols including tripropylene glycol (PG), tripropylene glycol n-butyl ether (TPnB), dipropylene glycol n-butyl ether (DPnB), propylene glycol phenol ether (PPh), ethylene glycol phenol ether (EPh); various nonylphenyl ethoxylates (NPE); and alcohols including butanol, hexanol and octanol. These surfactants, especially the lower molecular weight glycols such as TPnB and PPh, also act as ink solvents.

The cleaning composition may also contain a low VOC solvent (VOC content less than 5%). The solvent functions to soften and dissolve the ink film. Suitable solvents include methyl and butyl soyeate, methyl and butyl esters of tallow oil, methyl and butyl palmitate, methyl and butyl oleate, and methyl and butyl laureate.

The cleaning composition may also contain one or more VOC-exempt solvents such as, for example, TBAc, MeAc, PCBTF and acetone. The VOC-exempt solvents function as ink wetting agents which speed the penetration of the cleaning composition into the ink film.

Embodiments of the cleaning compositions may optionally contain one or more anti-streaking or anti-filming additives such as TPnB, dipropylene glycol n-butyl ether (DPnB), glycol ether EB, glycol ether DB, propylene glycol phenyl ether (PPh), and ethylene glycol phenyl ether (Eph). Such additives function to reduce oily residue by forming a water-reducible layer on the blanket and roller surface.

Embodiments of the compositions may further optionally contain an anti-redeposition additive such as gum Arabic, carboxy methyl cellulose or other natural gum as well as cellulose derivatives to prevent re-adhesion of lifted ink back to the blanket or roller.

Embodiments of the cleaning composition may further include a rag-drag reducer/lubricant additive to reduce ink tack. Suitable additives include Texanol alcohol ester (Eastman Chemical Co.), glycerine, highly branched and high-boiling technical white oils such as Magiesol 65XL (Penreco Magie Brothers), Magiesol 60, Drakesol 205 (Penreco Magie Brothers), Renoil 166 and Renoil 220T (Renkert Oil).

The cleaning composition further includes water as a carrier for the cleaning components.

To ensure that the cleaning composition is hand-safe (i.e., pH is less than 10 according to industrial convention), preferably no alkaline builder (e.g., triethanolamine) is added to the composition. Depending on the surfactant level and water content of the composition, the pH of the composition preferably ranges between 7.4 and 8.4.

Embodiments of the cleaning composition of the present invention can be made in any grounded vessel with modest agitation. The components may be added in the following order: 1) water, cationic surfactant, gum, glycols, Texanol, low VOC solvent, and TBAc (water-to-oil), or 2) cationic surfactant, glycols, Texanol, low VOC solvent, TBAc, gum and water (oil-to-water). Throughout the entire addition sequence, the appearance of the mixture may change from clear to translucent and to opaque or vice versa, as the composition transitions in and out of the microemulsion “zone.” However, when all of the components are properly mixed, the composition should be transparent and be light yellow or amber in color.

In the method of cleaning using embodiments of the cleaning composition of the present invention, the composition is applied to the surface of a selected printing press component such as an ink roller or printing blanket. Upon application, the composition is absorbed into the film of any ink present on the blanket or ink roller surface and starts to soften and plasticize the ink film. The softened film becomes emulsified into ink droplets and is carried away, e.g. by wiping.

In order that the invention may be more readily understood, reference is made to the following examples which are intended to illustrate the invention, but not limit the scope thereof.

### EXAMPLE 1

The following cleaning composition was prepared and had a VOC content of 10.4%±0.5%.

| Component | Parts by weight |
|---|---|
| cationic surfactant (dioctyldimethyl ammonium | 20 |
| bicarbonate)¹ | |
| anti-filming agent (glycol ether)² | 10 |
| resin solvent/drag reducer (Texanol)³ | 10 |
| Low VOC solvent (C12-C18 fatty acid ester)⁴ | 17.5 |
| ink wetter (tert-butyl acetate, VOC-exempt) | 7.5 |
| anti-grease/anti-deposit agent (gum arabic) | 1.5 |
| deionized water | 33.5 |

¹CS 1000 ™ available from Lonza, Inc.
²Dowanol TPnB available from Dow Chemical
³Texanol alcohol ester available from Eastman Chemical Co.
⁴SYLFAT 9012 available from Arizona Chemical

### EXAMPLE 2

The following cleaning composition was prepared and had a VOC content of 9.2%±1.4%.

| Component | Parts by weight |
|---|---|
| cationic surfactant (dioctyldimethyl ammonium | 12 |
| bicarbonate)¹ | |
| anti-filming agent (glycol ether)² | 9 |
| Co-emulsifier³ | 6.5 |
| resin solvent/drag reducer (Texanol)⁴ | 3 |
| Low VOC solvent (C12-C18 fatty acid ester)³ | 26 |
| ink wetter (tert-butyl acetate, VOC-exempt) | 2 |
| anti-grease/anti-deposit agent (gum arabic) | 1.5 |
| deionized water | 40 |

¹CS 1000 ™ available from Lonza, Inc.
²Dowanol TPnB available from Dow Chemical
³IGEPAL CO-520 available from Rhodia
⁴Texanol alcohol ester available from Eastman Chemical Co.
⁵SYLFAT 9012 available from Arizona Chemical

To evaluate the efficacy of the exemplary cleaning compositions, the composition of Example 1 was tested against two commercially available press cleaners with 100% VOC and 50% VOC, respectively. The cleaning test utilized three types of sheetfed inks (regular sheetfed, hybrid sheetfed, and UV sheetfed). The cleaning test procedure was as follows: a 1 mil (2.5 micron) clearance applicator was used to lay down a uniform ink film with a width of approximately 3 inches on an offset blanket. The ink film was then wiped with a non-woven pad (Webril Handi-Pad) pre-soaked with 2 ml of ink cleaner. A fresh pad was used for each pass, and the total number of passes required to completely lift the ink was counted. The ink film was then wiped with a non-woven pad (Webril Handi-Pad) pre-soaked with 2 ml of deionized water to remove the oily residue (i.e., glaze). A fresh pad was used for each pass, and the total number of passes required to completely remove the residue (indicated by absence of water bead-up) was counted.

Number of Passes to clean inks

| | | | | | Example 1 | |
|---|---|---|---|---|---|---|
| | CP-580 Wash | | Prisco 500 G | | (10% VOC) | |
| | (100% VOC) | | (50% VOC) | | | Run |
| Ink | Run 1 | Run 2 | Run 1 | Run 2 | Run 1 | 2 |
| Superior ® | 6-7 | 5-6 | 7-8 | 6-7 | 6-7 | 7-8 |
| SuperTech520 ™ | | | | | | |
| (K) | | | | | | |
| (Regular SF Ink) | | | | | | |
| Flint ® Gemini | 5-6 | 5-6 | 7-8 | 7-8 | 5-6 | 6-7 |
| Pro ™ (K) | | | | | | |
| (Hybrid SF Ink) | | | | | | |
| Ink System ™ | 5-6 | 4-5 | 7-8 | 6-7 | 5-6 | 4-5 |
| UV H ™ | | | | | | |
| 500 G (K) | | | | | | |
| (UV SF Ink) | | | | | | |

Number of Water Passes to Clean Oily Residue

| | | | | | Example 1 | |
|---|---|---|---|---|---|---|
| | CP-580 Wash | | Prisco 500 G | | (10% VOC) | |
| | (100% VOC) | | (50% VOC) | | | Run |
| Ink | Run 1 | Run 2 | Run 1 | Run 2 | Run 1 | 2 |
| Superior ® | 4-5 | 4-5 | 3-4 | 4-5 | 1-2 | 1-2 |
| SuperTech520 ™ | | | | | | |
| (K) | | | | | | |
| (Regular SF Ink) | | | | | | |
| Flint ® Gemini | 4-5 | 4-5 | 4-5 | 4-5 | 1-2 | 1-2 |
| Pro ™ (K) | | | | | | |
| (Hybrid SF Ink) | | | | | | |
| Ink System ™ | 3-4 | 3-4 | 4-5 | 5-6 | 1-2 | 1-2 |
| UV H ™ | | | | | | |
| 500 G (K) | | | | | | |
| (UV SF Ink) | | | | | | |

As can be seen, the cleaning composition of Example 1 exhibited a comparable cleaning performance to the commercial cleaners having a much higher VOC level. When comparing the effectiveness of cleaning oily residue from the printing blanket, the composition of Example 1 clearly outperformed the commercial cleaners. It took 1-2 passes of water wipe to completely eliminate the oily residue left by the cleaning composition of Example 1, while it took 3-6 passes to clean the oily residue left by the commercial cleaners.

To ensure that the cleaning composition of Example 1 is compatible with offset blankets, a standard 24-hour blanket swell test was conducted on both nitrile and EPDM type blankets (i.e., the surface of the blanket was in continuous contact with the cleaning composition for 24 hours). The offset blankets used were Patriot M-3000 and David M Ultra V (Day International, Inc.) used with regular and UV lithographic inks, respectively. The cleaning composition resulted in a swell of less than 0.004 inches for the Ultra V blanket and a swell of about 0.002 inches for the Patriot 3000 blanket. The results indicate that cleaning compositions made in accordance with embodiments of the present invention are safe for use on nitrile and EPDM blankets.

Having described the invention in detail and by reference to preferred embodiments thereof, it will be apparent that modifications and variations are possible without departing from the scope of the invention.

1. A non-corrosive cleaning composition for cleaning printing components containing ink thereon comprising a microemulsion comprising a cationic surfactant containing no halides, a co-microemulsifying surfactant, a solvent selected from a low-VOC solvent, a VOC-exempt solvent, or combinations thereof, and the balance water, said cleaning composition having a VOC content of less than about 10% +2%.

2. (canceled)

3. The cleaning composition of claim 1 wherein said cationic surfactant is selected from didecyldimethyl ammonium carbonate and didecyldimethyl ammonium bicarbonate.

4. The cleaning composition of claim 1 wherein said co-microemulsifying surfactant is selected from glycols and alcohols.

5. The cleaning composition of claim 1 wherein said low-VOC solvent is selected from methyl and butyl soyeate, methyl and butyl esters of tallow oil, methyl and butyl palmitate, methyl and butyl oleate, and methyl and butyl laureate.

6. The cleaning composition of claim 1 wherein said VOC-exempt solvent is selected from tert butyl acetate (TBAc), methyl acetate (MeAc), para chlorobenzene trifluoride (PCBTF), and acetone.

7. The cleaning composition of claim 1 wherein said composition is in the form of an oil-in-water microemulsion having a droplet size of less than about 100 nm.

8. The cleaning composition of claim 1 further including an anti-streaking additive comprising a glycol ether.

9. The cleaning composition of claim 1 further including a rag-drag reduction additive comprising an alcohol ester.

10. The cleaning composition of claim 1 further including an anti-redeposition additive selected from natural gum and cellulose derivatives.

11. A method of cleaning a printing press component comprising:
providing a printing press component containing ink on the surface thereof;
providing a cleaning composition comprising a cationic surfactant containing no halides, a co-microemulsifying surfactant, and a solvent selected from a low-VOC solvent, a VOC-exempt solvent, or combinations thereof;
applying said cleaning composition to the surface of said printing press component; and
wiping the surface of said printing press component to remove said ink.

12. The method of claim 10 wherein said cleaning composition has a swelling index of less than about 5.

13. The method of claim 11 wherein said printing press component comprises a printing blanket or inking roller comprised of nitrile or EPDM rubber.
